(19) United States
(12) Patent Application Publication
(10) Pub. No.: US 2007/0170291 A1
(43) Pub. Date: Jul. 26, 2007

(54) Cracking mill for grains of soy, wheat, and others

(76) Inventor: Mauro Massao Naganawa, Sao Paulo (BR)

Correspondence Address: J. John Shimazaki, P. O. Box 650741, Sterling, VA, 20165, US

(21) Appl. No.: 11/337,258

(22) Filed: Jan. 23, 2006

(51) Int. Cl. B02C 19/00

(52) U.S. Cl. 241/159; 241/7

(57) ABSTRACT

The present invention comprises a system for cracking grain preferably comprising four cracking cylinders, wherein the cylinders are preferably individually and independently driven by a separate motor, with motoreducers and frequency inverters, and controlled by a speed divider, which is capable of independently adjusting the speed of each cylinder. The position of the cylinders is preferably adjustable to adjust the spacing between opposing cylinders. Humidity sensors can be provided to determine the moisture content of the grain being processed. These adjustments are preferably automatically controlled by a programmable logic control, installed on an electric control panel.

### FIELD OF THE INVENTION

The invention relates to mills for cracking grains, and in particular, to an improved cracking mill having independently powered variable speed opposing cylinders.

### BACKGROUND OF THE INVENTION

As is known to those skilled in the art, cracking mills are known for being essential for soy seed preparation, including hull separation, flake conditioning and extraction. Appropriate handling and operation of cracking mills is required to obtain consistent particle size and hull separation, with the least amount of leftover particles.

Ordinary power transmission systems used in current cracking mills are based on belts and pulleys to transmit power to the cylinders, thus limiting the ability of the system to provide differential speed changes between cylinders. Additionally, small particles often stay bound to the hull, resulting in high hull fat content, which can represent economical losses in connection with the grinding operation. Also, as soy seeds are fairly abrasive, when conventional cracking mills are operated and maintained, the cylinders are often subjected to excessive wear. Moreover, manufacturing plants are often asked to produce greater quantities, at higher speeds, but at lower costs, aiming at production maximization.

Therefore, to attain the above production goals, it has often been the case that the only feasible alternative was to increase the cylinder speed. But because of increased capacity, i.e., tons per day, cylinder grinding and rifling was frequently required to be performed, resulting in more time spent performing maintenance.

In this respect, the higher the cylinder speed, the larger the dimensional capacity must be, or, the larger the cylinders existing measures must be. In such case, the speed differentials are often set to particular levels, in order to produce the appropriate particle size, in an attempt to minimize the amount of fine particles that are produced, which are responsible for generating aggregate oil in the cracked hull volume.

Larger cylinders can reach higher production levels, as well as acceptable time intervals between riflings. But by increasing the cylinder dimensional capacity, a reduction often occurs in the number of hours the machine can be operated before mandatory rifling is required. Therefore, the cracking capacity became dependant strictly on the cylinder size and on the operation speed.

In this respect, it should be noted that the way to estimate the capacity of a cracker resides in calculating the cylinder surface and the peripheral speed, and establishing the cylinder volumetric capacity in keeping with certain parameters, such as material density, amount of gross material to be transformed, and work efficiency, which must be applied to obtain real values regarding the capacity of the cylinders with their respective dimensions, diameter and length. The cylinder length is an important component of a machine capacity, and the cylinder diameter, in turn, must increase as the length increases, in order to keep an appropriate division between hardness and stiffness. In practical terms, for example, the length/diameter division or ratio of up to 6:1 will yield more than the appropriate hardness for soy seed applications. The cylinder speed also plays a relevant role concerning the capacity of the cracker, emphasizing that it wears the cylinder rifles to a certain extent, as well as generates significant small particles in the hull. Nowadays, the capacity of a cracking mill is often reduced to 30% to 50% of its actual manufacturing capacity, when efforts are made to obtain optimal productivity in keeping with the useful life between cylinder riflings.

Based on the above, and aiming at offering technical solutions in the responsible art, the present invention has been created and developed.

### SUMMARY OF THE INVENTION

The present invention relates to improvements in the technical design of a cracking mill for grains, such as soy, wheat and others. The present system eliminates and replaces the grinding systems that are currently provided with belt and pulley transmission mechanisms. Instead, the present system employs the use of individually operated and powered cylinders that can be operated independently of each other, i.e., at different adjustable speeds, by individual motors, motoreducers and frequency inverters.

The speed of each cylinder is preferably adjustable such that the speed differential between opposing cylinders can be optimized for any given application. The ability to vary the speed differential between cylinders leads not only to being able to search and find the optimum speed, but also allows the grain to be cracked according to the optimum settings for the type of grain being processed. Moreover, using individual motors for each cylinder makes the cracking equipment transmission system easy to maintain, i.e., helps facilitate maintenance, including improving assembling and disassembling time.

In the present invention, because power transmission is not performed by belts and pulleys, power losses can be minimized, i.e., by high-output reducers, and frequency inverters, which avoid the power consumption peaks that can occur (i.e., at every starting which can often occur at many manufacturing plants). Also, the use of automatic hydraulic cracking cylinders ensures that the adjustment between cylinders occurs automatically, i.e., with the use of a programmable logic control (PLC) which can control and manage the operation of the system. The automated system allows for the speed differential between cracking cylinders to be adjusted, which allows the optimum speed settings between them to be found.

Grain moisture sensors are preferably provided to supply the PLC with data that can be used to control the adjustments that are made, i.e., by means of the inverters, etc. This enables the system to change the cylinder speed differential to allow for maximum cracking output. The equipment is preferably completely automated (does not require manual operation), and in some embodiments, may be controlled via the internet.

The present invention features technical variants which allow for better quality grain cracking, as well as optimal power economy, which adds value. For example, a homogeneous screen can be provided over the cylinders, or a magnetic plate for retaining metallic particles can be provided. Moreover, a potentiometric ruler can be provided to adjust the spacing between the cylinders, wherein the relative positions of the cylinders can be powered by a hydraulic system controlled by an electric control panel. Based on the above, the present invention fills an important gap in the marketplace, and offers the technical advantages described above.

### BRIEF DESCRIPTION OF THE DRAWINGS

FIG. 1 represents a side view of the present invention;

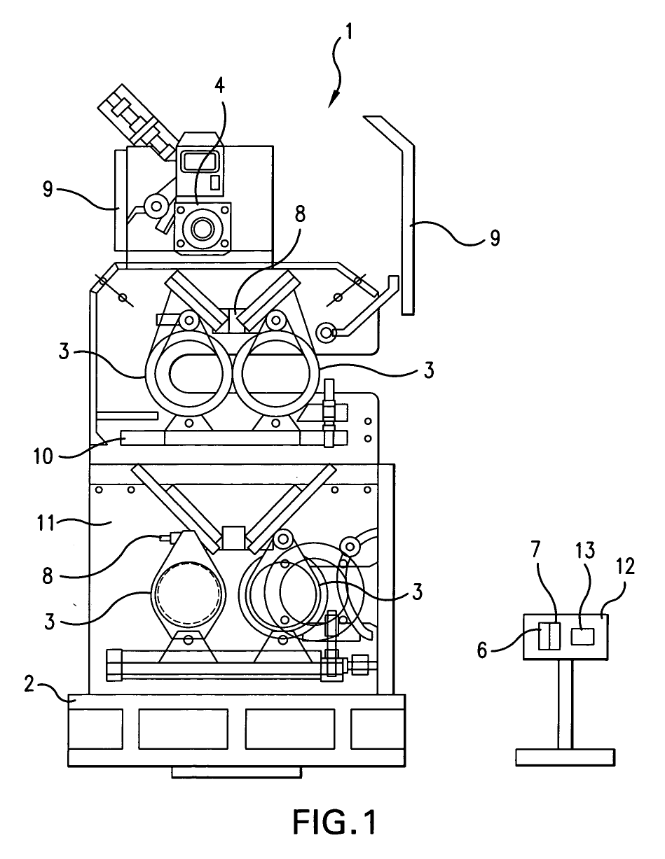

FIG. 2 corresponds to a plan section view of two upper cylinders positioned on the present invention; and

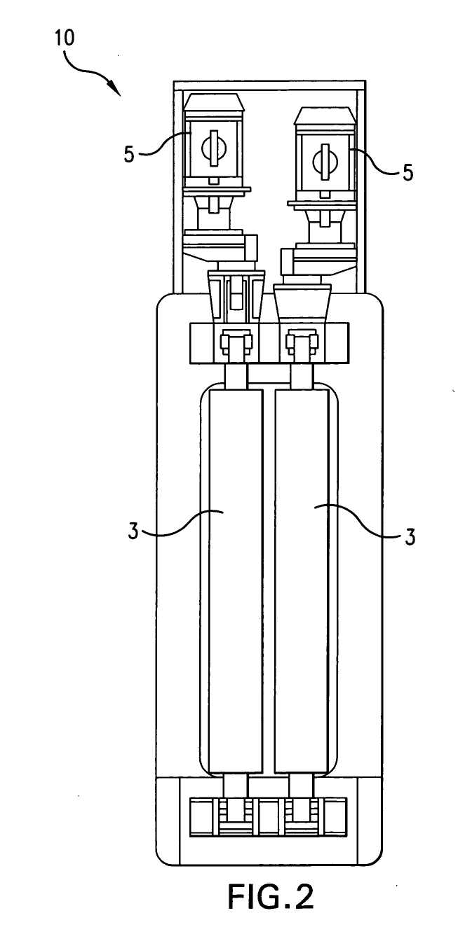

FIG. 3 refers to a plan section view of two lower cylinders positioned on the present invention.

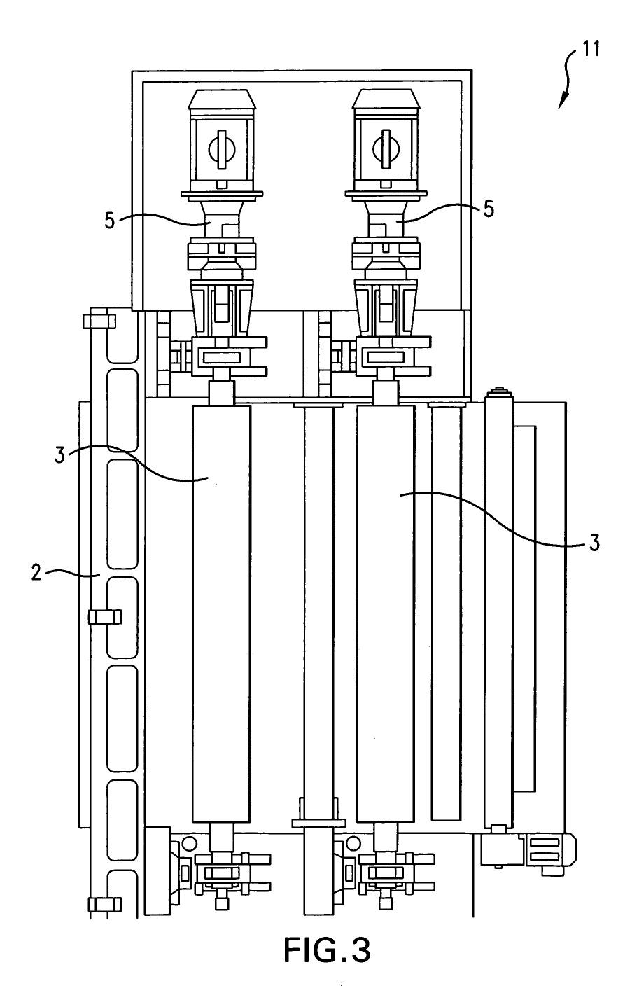

### DETAILED DESCRIPTION OF THE INVENTION

As recited in the previous paragraphs, the technical design introduced herein is a piece of equipment developed for cracking and obtaining small-sized consistent particles and good hull separation without creating excessive small ground particles, which would result in high fat content in the hull, and consequent economical losses in the final product.

As shown in the drawings, the technical design of the present invention comprises a stand (2) upon which the equipment is positioned, wherein two blocks (10) and (11) are positioned thereon. The equipment assembly preferably comprises a lower block (11) and an upper block (10), each of which has a pair of rotating and opposing cracking cylinders (3) thereon, respectively supported and fixed on bearings located on the blocks. Preferably, in each pair, one of the cracking cylinders (3) is a moving one and the other, a fixed one, although both can be adapted to move if desired. A hydraulic system (9) is preferably provided to move one of the cylinders, such that in each pair, the cylinders can be moved relative to each other, i.e., such that the space between them can be adjusted. A potentiometric ruler (8) is preferably provided to accurately determine the distance between the cylinders at any given time.

The equipment preferably has a supplier (4) for supplying grain into the rotating cylinders, i.e., in an area extending between the opposing cylinders (3) in each pair. Moreover, in the preferred embodiment, a homogeneous screen can be provided over the cracking cylinders (3), and a magnetic plate can be provided to separate metallic particles from the grain.

Each cylinder is preferably operated and powered by a separate motor, which can be adjusted with a motoreducer (5), as well as a frequency inverter (6), which can enable the speed of the cylinders to be adjusted independently of each other. There is preferably a speed divider (7) to facilitate the speed differential between opposing cylinders. The motoreducer (5) functions to reduce the rotational speed of the cylinder. For example, the speed of one cylinder might initially be set at 1800 rpm, based on the type of application to be performed, wherein the motoreducer (5) can reduce the speed to 300 rpm. In such case, a motoreducer with a 6:1 reduction ratio would be used. Thus, the motoreducer operates like a gearbox, except that it reduces the speed to the same number of revolutions per minute each time an adjustment is made. Other adjustment means are also contemplated.

The frequency inverter (6) operates to adjust the speed of the motor on each cylinder (3), by inverting the ratio, such that the speed of the cylinders can be adjusted up again, when necessary. For example, after the motoreducer (5) reduces the speed of the cylinders by the appropriate ratio, the inverter can be used to increase the speed, i.e., in the opposite direction, by the same ratio, or by a different ratio. The speed of the cylinders is preferably controlled and managed by a programmable logic controller (13), which is operated by an electric control panel (12).

The present invention is characterized in that it preferably comprises a stand, designed to ensure machine stability, made of cast iron or the like, bearings cast in Nodular iron, milled and internally ground for fitting and coupling to the guides, preferably cast in the same material, for alignment, easy and fast removal of the whole set, also emphasizing that the covers have been designed to eliminate lubrication.

The cylinder rolls preferably have self-compensating bearings which are lubricated before assembly with special grease, not requiring lubrication until the next maintenance. The preferred cracking cylinders (3), which are the components responsible for hull separation and flake conditioning, are preferably made from centrifuged, chilled, bimetallic casting, with a preferred hardness ranging from 510 to 550 HB, with axle ends in SAE 4140 steel or the like, dynamically balanced and rifled.

The supplier (4) is preferably built in polished stainless steel with a rotating cylinder, designed to produce a homogeneous screen over the cylinders, emphasizing that it preferably features a magnetic plate intended to extract metallic corpuscles, and driven by a pneumatic system for automatically opening and closing the equipment, which system is preferably controlled by the PLC. Additionally, there is preferably a set of potentiometric rulers (8) working as a system for cylinder setting, which allows point-to-point reading, ensuring moving roll positioning repeatability.

The equipment stand (2) is preferably built in stainless steel with a reinforced internal frame, eliminating vibration, with the back portion closed, not requiring an opening for cylinder removal, and the front portion featuring tilting doors and electric locks, intended for fast opening upon cylinder disassembly. The equipment preferably comprises an electric control panel (12) with 380 V charge and 24 V control, wherein the four motoreducers (5) can be driven and adjusted with varying speeds, and controlled by a state-of-the-art PLC (13), making speed variation feasible for any cylinder, on an independent basis, allowing higher grinding output. The supplier (4) opening can be controlled by the PLC, providing total assurance of optimal grain flow into the cylinders.

A moisture or humidity sensor is preferably provided at the entrance of the equipment, and another sensor is preferably provided in the suppler (4). The sensors preferably measure the humidity of the grain, and this measurement is supplied as data to the PLC. The data is used to determine whether the speed of the cylinders is appropriate for the type and condition of the grain being cracked. For example, the speed differential between opposing cylinders is preferably low when the grain is dry, and high when the grain is humid. When the condition of the grain is detected by the sensor, this data can be forwarded to the PLC, wherein the PLC can make adjustments to the speed and/or settings to enhance and optimize the performance of the cylinders.

Preferably, a consistent volume of small particles is obtained during the grain cracking process, separating the seed from the hull, by using a differential speed divider (7), as well as the frequency inverters (6) and motoreducers (5). The optimal speed differential varies with the type of process used, which may be, for example, a “hot” hull separation system, in which seeds are cracked while the temperature is high, generating strong, resistant and gummy-looking pulp. This requires a high speed differential. Also, typical speed differentials, recommended and used in a hot hull separation system are usually in the range of 1.8:1 to 2.4:1, with a 2:1 ratio being the most common. Lower speed differentials increase seed compression, as it crosses the cylinders, wherein the grain can be more mashed than effectively cut. This mixing or mashing effect leads to good separation from the hull, although it can also leave unacceptable levels of large particles behind, i.e., for later process steps.

For cold hull separation systems, differential speed dividers (7) with lower ratios may be used in an acceptable way. Cracking mills usually processing soy seeds traditionally use 1.25:1 or 1.33:1 differential dividers.

More recent efforts have shown that 1.5:1 dividers offer better output with respect to effective hull separation and minimum generation of small particles impregnated into the hulls. However, smaller dividers can cause seed compression, rather than rupture, and higher speed differentials tend to process the seeds excessively, resulting in high levels of small particle generation.

As a secondary consideration, it should be considered that the cylinders' peripheral speed eventually establishes the effective capacity of a cracking mill, i.e., when the cylinder speed increases, so will the machine capacity. However, as the cylinder speed increases, the product tendency to slide down the cylinder channels also increases, and as the cylinder diameter is increased, the sliding effect decreases, due to the increased angle of the cylinder channels.

To minimize this sliding between cylinders, i.e., as the rifles get worn and lose edge, it is required to increase the spacing between the cylinders, which operation is performed by adjusting the potentiometric rulers (8), which is part of a cylinder adjustment system allowing point-to-point reading, assuring that the cracking cylinders (3) can be accurately positioned repeatability. The cylinder positions are driven by a hydraulic system (9) controlled by the PLC (13), and the electric control panel (12).

It is important to emphasize that the difficulty upon compensating for the cracker rifle wear may lead to a situation in which the seeds can get jammed between the cylinders, resulting in reduced machine capacity and increased cylinder rifle wear.

The technical advantages provided by the present invention include, without limitation, the following:

1. The cracking equipment object of the present invention allows varying the speed differential (7) between the breaking cylinders (3), leading not only to searching the best speed between them, but also a variation in speed which will allow the grains to be cracked according to the optimum settings for the process.

2. This seed cracking equipment transmission system is very easy to disassemble, which facilitates cracking cylinder maintenance, as well as assembling and disassembling time.

3. Power economy is improved, as the transmission is not performed by belts and pulleys (which can cause minimum 10% loss), but by high-output reducers. The equipment also has a frequency inverter system (6) which avoids power consumption peaks at every starting (plants usually have to stop the equipment frequently during any given 24 hour period).

4. Automatic hydraulic cracking cylinders (3) which ensure that the adjustment between cylinders occurs automatically, in conjunction with the use of the PLC (13), as well as allows the speed differential (7) variation between cracking cylinders (3), which allows not only searching the best speed between them, but also the grain to be cracked according to the optimum settings for the process.

5. The grain moisture or humidity sensors supply data to the PLC (13), which can control, by means of the inverters (6), any changes in cylinder speed differential, to allow maximum cracking output.

6. The equipment is completely automatic (does not require manual operation), and may be controlled via Internet. In this respect, it should be noted that the system can be operated manually, by requiring the operator to physically inspect the grains as they are being processed, wherein the operator can adjust the settings on the PLC and control panel for the appropriate application, i.e., to alter the speed differentials and/or the cylinder positions. On the other hand, the present system can be set to operate automatically, by using the humidity sensor to automatically determine the condition of the grain, in which case the PLC can be adapted to automatically adjust the speed differential and/or cylinder positions, based on the data supplied to the PLC. The system is preferably programmed with specific ratios and settings for specific conditions, such that the system knows in advance how the settings should be adjusted, depending on the moisture content of the grain.

For the above reasons, the present cracking mill invention is novel, and features technical variants which allow for better quality grain cracking, as well as optimal grain cracking for later processes, and power economy, which adds value.

It can be observed, based on the descriptions and illustrations contained herein, that this is a technical design which fills an important gap in the marketplace, and also offers the technical advantages described above.

What is claimed is:

1. A grain cracking device, comprising:
a pair of opposing cylinders having a first cylinder and a second cylinder, adapted to be movable relative to each other;
a supplier for feeding grains into an area between said first and second cylinders;
an individual motor for driving each of said first and second cylinders, wherein the speed of each cylinder can be individually adjusted; and
a control device for controlling and managing the operation of the cylinders.

2. The device of claim 1, wherein the device has two pairs of opposing cylinders, wherein a first upper pair is positioned over a second lower pair.

3. The device of claim 1, wherein the speed of the motors are adjusted by motoreducers and frequency inverters.

4. The device of claim 1, wherein the control device is a programmable logic computer capable of automatically adjusting the speed of the cylinders.

5. The device of claim 1, wherein at least one humidity sensor is provided to supply data to the control device.

6. The device of claim 1, wherein at least one homogeneous screen is provided over the cylinders.

7. The device of claim 1, wherein at least one magnetic plate for retaining metallic particles is provided.

8. The device of claim 1, wherein at least one potentiometric ruler is provided to adjust the spacing between the cylinders.

9. The device of claim 1, wherein the relative positions of the opposing cylinders are powered by a hydraulic system controlled by the control device with an electric control panel.

10. A grain cracking device, comprising:
two pairs of opposing cylinders, each pair having a first cylinder and a second cylinder, adapted to be movable relative to each other;
a supplier for feeding grains into an area between an upper pair of cylinders;
an individual motor for driving each of said cylinders, wherein the speed of each cylinder can be individually adjusted; and
a control device for controlling and managing the operation of the cylinders.

11. The device of claim 10, wherein the device said upper pair of cylinders is positioned over a second lower pair of cylinders.

12. The device of claim 10, wherein the speed of the motors are adjusted by motoreducers and frequency inverters.

13. The device of claim 10, wherein the control device is a programmable logic computer capable of automatically adjusting the speed of the cylinders.

14. The device of claim 10, wherein at least one humidity sensor is provided to supply data to the control device.

15. The device of claim 10, wherein at least one homogeneous screen is provided over the cylinders.

16. The device of claim 10, wherein at least one magnetic plate for retaining metallic particles is provided.

17. The device of claim 10, wherein at least one potentiometric ruler is provided to adjust the spacing between the cylinders.

18. The device of claim 10, wherein the relative positions of the opposing cylinders are powered by a hydraulic system controlled by the control device with an electric control panel.

19. The device of claim 10, wherein the relative positions of the opposing cylinders are adjusted by moving only one of the two opposing cylinders in each pair.

20. A grain cracking device, comprising:
a pair of opposing cylinders having a first cylinder and a second cylinder;
a supplier for feeding grains into an area between said first and second cylinders;
an individual motor for driving each of said first and second cylinders, wherein the speed of each cylinder can be individually adjusted; and
a control device for controlling and managing the operation of the cylinders.
